(19) United States
(12) Patent Application Publication
(10) Pub. No.: US 2026/0211613 A1
(43) Pub. Date: Jul. 23, 2026

(54) ADJUSTING VOLUME OF AUDIO PLAYBACK BASED ON MICROPHONE STATUS

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 19/033,239

(22) Filed: Jan. 21, 2025

(51) Int. Cl. G06F 3/16; H04R 3/00

(52) U.S. Cl. CPC G06F 3/165; H04R 3/00; H04R 2430/01

(57) ABSTRACT

In aspects of adjusting volume of audio playback based on microphone status, a first computing device implements a volume manager that determines whether a microphone associated with a first computing device is turned on. The volume manager detects audio playback that is output from speakers of a second computing device located within a threshold proximity to the first computing device. The volume manager then outputs a trigger to cause one or more of the second computing device to adjust a volume of the audio playback or the first computing device to mute the microphone based on a determination that the microphone associated with the first computing device is turned on.

### BACKGROUND

Computing devices are capable of outputting multiple types of audio playback using speaker systems incorporated into the computing devices. For example, the audio playback may include music, video audio, podcasts, recordings, game audio, or any other type of audio. However, the audio playback results in challenges, such as the audio playback interrupting activities performed using other computing devices, including audio calls, virtual meetings, and recordings in some examples.

### BRIEF DESCRIPTION OF THE DRAWINGS

Implementations of techniques for adjusting volume of audio playback based on microphone status are described with reference to the following Figures. The same numbers may be used throughout to reference like features and components shown in the Figures.

FIG. 1 illustrates an example system for adjusting volume of audio playback based on microphone status in accordance with one or more implementations as described herein.

FIG. 2 further illustrates an example of adjusting volume of audio playback based on microphone status, including determining a status of a microphone associated with a first computing device, in accordance with one or more implementations as described herein.

FIG. 3 further illustrates an example of adjusting volume of audio playback based on microphone status, including sending a trigger to a second computing device to adjust a volume of audio playback, in accordance with one or more implementations as described herein.

FIG. 4 further illustrates an example of adjusting volume of audio playback based on microphone status, including sending a trigger to a second computing device to turn off autoplay, in accordance with one or more implementations as described herein.

FIG. 5 further illustrates an example of adjusting volume of audio playback based on microphone status, including determining whether a user of the first computing device is expected to speak, in accordance with one or more implementations as described herein.

FIG. 6 further illustrates an example of adjusting volume of audio playback based on microphone status, including sending a trigger to a second computing device to adjust a volume of audio playback in response to determining that the user of the first computing device is expected to speak, in accordance with one or more implementations as described herein.

FIG. 7 further illustrates an example of adjusting volume of audio playback based on microphone status, including determining that the user of the first computing device is not expected to speak, in accordance with one or more implementations as described herein.

FIG. 8 further illustrates an example of adjusting volume of audio playback based on microphone status, including sending a trigger to the first computing device to mute a microphone in response to determining that the user of the first computing device is not expected to speak, in accordance with one or more implementations as described herein.

FIG. 9 is a flowchart illustrating an example of adjusting volume of audio playback based on microphone status in accordance with one or more implementations as described herein.

FIG. 10 illustrates an example method for adjusting volume of audio playback based on microphone status in accordance with one or more implementations of the techniques described herein.

FIG. 11 illustrates an example method for adjusting volume of audio playback based on microphone status in accordance with one or more implementations of the techniques described herein.

FIG. 12 illustrates an example method for adjusting volume of audio playback based on microphone status in accordance with one or more implementations of the techniques described herein.

FIG. 13 illustrates various components of an example device that may be used to implement the techniques for adjusting volume of audio playback based on microphone status in accordance with one or more implementations as described herein.

### DETAILED DESCRIPTION

Implementations of the techniques for adjusting volume of audio playback based on microphone status may be implemented as described herein. A first computing device and a second computing device, such as any type of mobile phone or computing device, may be configured to perform the techniques for adjusting volume of audio playback based on microphone status. In one or more implementations, a volume manager, housed in the first computing device, the second computing device, a central computing device, or a network-based cloud accessible to the first computing device and the second computing device, can be used to implement aspects of the techniques described herein.

Computing devices may facilitate a variety of types of communication with other computing devices over a network. For example, audio call applications allow users of computing devices to have a conversation over the network, while virtual meeting applications allow users to virtually meet face-to-face using live video feed captured and displayed using the computing devices. Additionally, audio and/or video may be recorded using the computing devices for later distribution. These types of communication generally receive audio input at a microphone of a communication device as part of the audio call, the virtual meeting, or the recording.

Computing devices are also capable of outputting multiple types of audio playback using speaker systems incorporated into the computing devices. For example, the audio playback may include music, video audio, podcasts, recordings, game audio, or any other type of audio. However, challenges arise when a first computing device is conducting an audio call, a virtual meeting, or a recording, while a second computing device located within a close proximity to the first computing device is engaged in outputting the audio playback. For instance, a virtual meeting conducted on the first computing device by one user is interrupted by audio from a video played by a second computing device located in the same room by another user. The audio from the video, for instance, may be unintentionally captured by the microphone of the first computing device, causing frustration and embarrassment for the user of the first computing device participating in the virtual meeting.

Techniques and systems are described for adjusting volume of audio playback based on microphone status that overcome these limitations. To begin, the volume manager identifies that a first computing device is engaged in a communication activity involving input from a microphone, such as an audio call, a virtual meeting, or a recording, while a second computing device is engaged in outputting audio playback from a speaker system. For instance, the volume manager may determine that a status of a communication application is active on the first computing device based on received usage data. Additionally, the volume manager may determine that a status of media playing on the second computing device is active, indicating that audio output associated with music, video audio, podcasts, recordings, game audio, or any other type of audio is output for consumption. The first computing device in this example is determined to have higher priority than the second computing device because the first computing device is engaged in an activity involving use of a microphone, while the second computing device is engaged in consuming media.

In some example implementations, the volume manager may also determine that the first computing device and the second computing device are physically located within a close proximity of each other, which may be defined as a threshold distance or presence in the same room. To do this, the volume manager receives location data from a location device of the first computing device and the second computing device and compares the location data to determine whether the first computing device and the second computing device are located within the proximity of each other.

The volume manager also determines whether a status of the microphone of the first computing device is on or off. Because the first computing device and the second computing device are within the threshold distance of each other, the audio playback may interrupt the audio call, the virtual meeting, or the recording occurring using the first computing device when the microphone is on.

For this reason, if the volume manager determines that the microphone of the first computing device is on and the user is currently speaking, the volume manager initiates a volume adjustment, such as muting speakers of the second computing device, to prevent the audio playback from the second computing device from interrupting the audio call, the virtual meeting, or the recording on the first computing device. Additionally, the volume manager may cause display of a message on the second computing device alerting the user of the second computing device that the microphone of the first computing device is on and therefore the speakers of the second computing device have been muted. In some example implementations, the volume manager also pauses autoplay on the second computing device.

If the volume manager determines that the microphone of the first computing device is on, but the user of the first computing device is not currently speaking, the volume manager may leverage a machine learning model to determine whether the user is expected to speak. If the volume manager determines that the user is expected to speak, the volume manager initiates the volume adjustment at the second computing device to prevent the audio playback from interrupting the user when the user speaks. However, if the volume manager determines that the user is not expected to speak, the volume manager mutes the microphone of the first computing device to prevent unwanted audio playback from the second computing device from being received by the microphone.

In additional example implementations, the microphone of the first computing device may be turned off. In this situation, the volume manager may also leverage the machine learning model to determine whether the user is expected to speak. If the volume manager determines that the user is expected to speak, the volume manager initiates the volume adjustment at the second computing device to prevent the audio playback from interrupting the user when the user unmutes the microphone.

The described techniques for adjusting volume of audio playback based on microphone status overcome the limitations of conventional systems. For example, determining that a microphone associated with a first computing device is turned on and that audio playback is output from speakers of a nearby second computing device is used to determine whether the audio playback is interrupting an activity performed using the first computing device involving the microphone. Additionally, sending a trigger to the second computing device to adjust a volume of the audio playback, such as muting the audio playback, reduces interruptions to the activity performed using the microphone of the first computing device. This alleviates user frustration that may stem from unwanted audio playback interfering with audio calls, virtual meetings, and recordings conducted by the first computing device.

While features and concepts of the described techniques for adjusting volume of audio playback based on microphone status is implemented in any number of different devices, systems, environments, and/or configurations, implementations of the techniques for adjusting volume of audio playback based on microphone status are described in the context of the following example devices, systems, and methods.

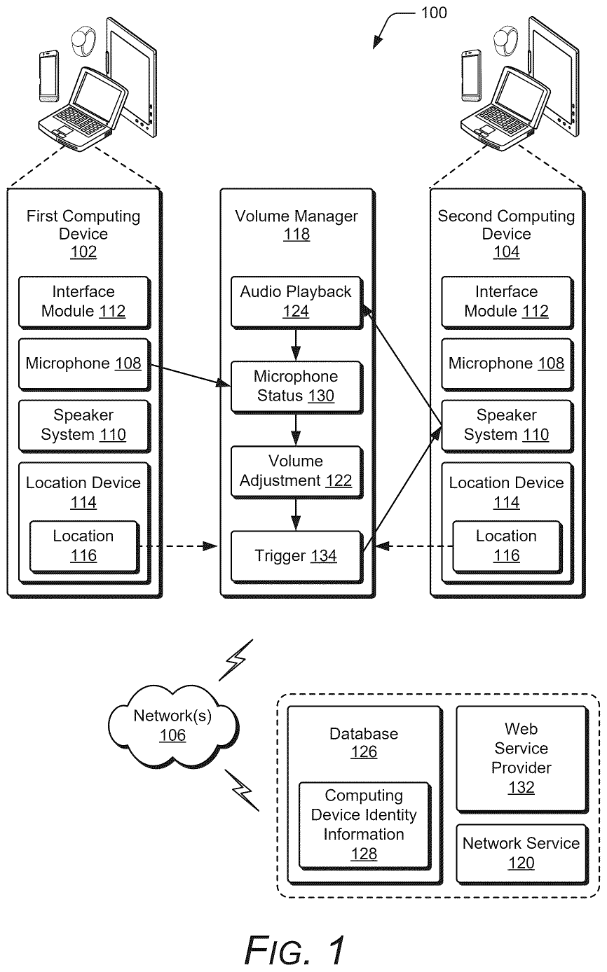

FIG. 1 illustrates an example system 100 for adjusting volume of audio playback based on microphone status. The system 100 includes a first computing device 102, a second computing device 104, and a communication network 106. Examples of the first computing device 102 and the second computing device 104 include at least one of any type of a wireless device, mobile device, mobile phone, flip phone, client device, companion device, tablet, computing device, communication device, entertainment device, gaming device, media playback device, any other type of computing and/or electronic device.

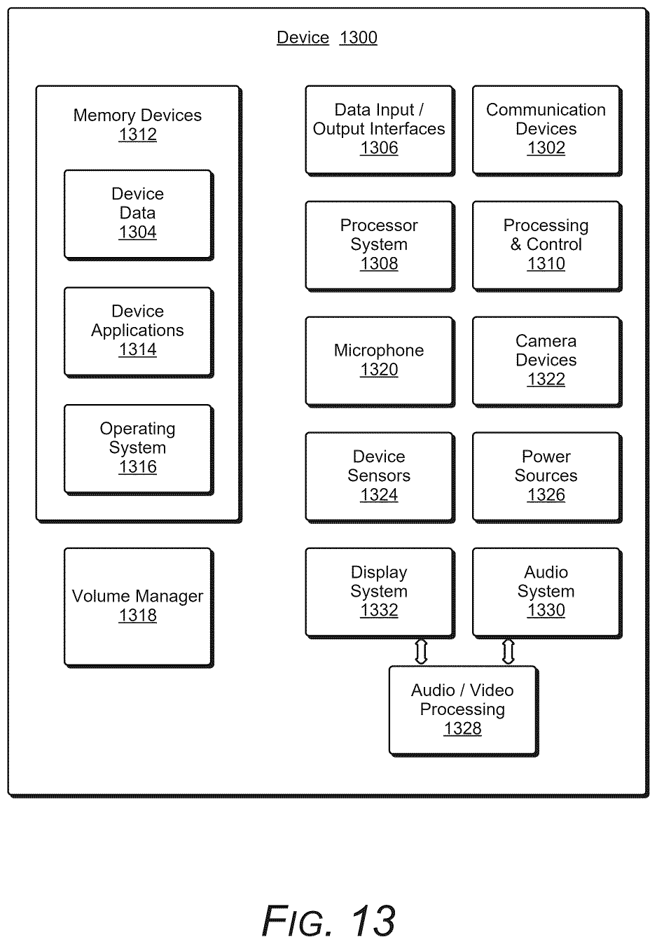

The first computing device 102 and the second computing device 104 can be implemented with various components, such as a processor system and memory, as well as any number and combination of different components as further described with reference to the example device shown in FIG. 13. In implementations, the first computing device 102 and the second computing device 104 are equipped with a microphone 108 to receive audio input at the first computing device 102 and the second computing device 104. The audio input, for instance, may be audio data related to spoken dialog in the environment of the first computing device 102 or the second computing device 104. The first computing device 102 and the second computing device 104 are also equipped with a speaker system 110 to output audio playback. For example, the audio playback may include video audio, call audio, music, or other audio from any type of media.

In some implementations, the devices, applications, modules, servers, and/or services described herein communicate via the communication network 106, such as for data communication with the first computing device 102 and the second computing device 104. The interface module 112 includes a wired and/or a wireless network. The interface module 112 is implemented using any type of network topology and/or communication protocol and is represented or otherwise implemented as a combination of two or more networks, to include IP based networks, cellular networks, and/or the Internet. The communication network 106 includes mobile operator networks that are managed by a mobile network operator and/or other network operators, such as a communication service provider, mobile phone provider, and/or Internet service provider.

The first computing device 102 and the second computing device 104 include various functionalities that enable the devices to implement different aspects of adjusting volume of audio playback based on microphone status, as described herein. In one or more examples, an interface module 112 represents functionality (e.g., logic and/or hardware) enabling the first computing device 102 and the second computing device 104 to interconnect and interface with other devices and/or networks, such as the communication network 106. For example, the interface module 112 enables wireless and/or wired connectivity of the first computing device 102 and the second computing device 104.

The first computing device 102 and the second computing device 104 can include and implement an application, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the first computing device 102 or the second computing device 104. Generally, an application user interface, or any other type of video, image, graphic, and the like is digital image content that is displayable on the display screen of the first computing device 102 and the second computing device 104. The application may be accessible to the first computing device 102 and the second computing device 104 from an application service provider via the communication network 106.

In implementations, the first computing device 102 and the second computing device 104 may include any type of location device 114, such as a GPS transceiver or other type of geo-location device, to determine a location 116 of the first computing device 102 and the second computing device 104. Notably, any of the devices described herein, to include components, modules, services, computing devices, camera devices, and/or the tracking tags, can share the GPS data between any of the devices, whether they are GPS-hardware enabled or not. Additionally or alternatively, the first computing device 102 and the second computing device 104 can also include various radios for wireless communication in the environment, such as a UWB radio, Bluetooth radio, or a Wi-Fi radio implemented for wireless communications with the other devices in the environment.

In the example system 100 for adjusting volume of audio playback based on microphone status, the first computing device 102 and/or the second computing device 104 implements a volume manager 118. For example, the volume manager 118 can represent functionality that resides on the first computing device 102 and/or the second computing device 104. Alternatively or additionally, the volume manager 118 may be implemented using a network service 120, such as a cloud-based service, in communication with the first computing device 102 and the second computing device 104 via the communication network 106. Alternatively or additionally, the volume manager 118 is implemented in an external device in communication with the first computing device 102 and the second computing device 104 via the communication network 106. As shown in this example, the volume manager 118 represents functionality (e.g., logic, software, and/or hardware) enabling aspects of the described techniques for adjusting volume of audio playback based on microphone status. The volume manager 118 can be implemented as computer instructions stored on computer-readable storage media and can be executed by a processor system of the first computing device 102 and/or the second computing device 104. Alternatively, or in addition, the volume manager 118 can be implemented at least partially in hardware of the device.

In one or more implementations, the volume manager 118 includes independent processing, memory, and/or logic components functioning as a computing and/or electronic device integrated with the first computing device 102 and/or the second computing device 104. Alternatively, or in addition, the volume manager 118 can be implemented in software, in hardware, or as a combination of software and hardware components. In this example, the volume manager 118 is implemented as a software application or module, such as executable software instructions (e.g., computer-executable instructions) that are executable with a processor system of the first computing device 102 and/or the second computing device 104 to implement the techniques and features described herein. As a software application or module, the volume manager 118 can be stored on computer-readable storage memory (e.g., memory of a device), or in any other suitable memory device or electronic data storage implemented with the controller. Alternatively or in addition, the volume manager 118 is implemented in firmware and/or at least partially in computer hardware. For example, at least part of the volume manager 118 is executable by a computer processor, and/or at least part of the content manager is implemented in logic circuitry.

In this example system 100, the volume manager 118 determines a volume adjustment 122 for the speaker system 110 of the second computing device 104 to lower a volume of or mute the audio playback 124. Therefore, the audio playback 124 avoids interfering with an active audio call, a virtual meeting, a recording, or other live interaction performed using the first computing device 102.

To do this, the volume manager 118 determines that the first computing device 102 and the second computing device 104 are physically located within a close proximity of each other (i.e., are co-located), such as within a threshold distance of each other. To do this, the volume manager 118 leverages the location device 114 to determine the location 116 of the first computing device 102 and the second computing device 104. For example, the location device 114 is a GPS device, and the volume manager 118 determines the location 116 based on GPS data. Additionally or alternatively, the location device 114 involves a UWB tag incorporated in the first computing device 102 and the second computing device 104, and the volume manager 118 determines the first computing device 102 is within the threshold distance by comparing the signal path loss from received signals from the UWB tags. In some implementations, the volume manager 118 accesses a database 126 via the communication network 106 that includes computing device identity information 128. Furthermore, in some example implementations, the proximity is determined based on the first computing device 102 and the second computing device 104 being positioned within the same room or other defined area.

Additionally, in some implementations the volume manager 118 determines that the first computing device 102 is actively engaged in an audio call, a virtual meeting, a recording, or other live interaction. For example, the volume manager 118 detects that an application or webpage that facilitates calls, meetings, or recordings is launched and active on the first computing device 102. The user of the first computing device 102, for instance, is using the first computing device 102 to interact with others via the communication network 106, film a video, or record audio for later distribution. Any of these activities may be interrupted by the audio playback 124 output from the speaker system 110 of the second computing device 104.

To determine whether the audio playback 124 would interrupt the audio call, the virtual meeting, or the recording performed using the first computing device 102, the volume manager 118 also determines a microphone status 130 of the microphone 108 of the first computing device 102. For example, if the microphone status 130 of the microphone 108 of the first computing device 102 is turned on and currently recording the user of the first computing device 102, then the audio playback 124 from the speaker system 110 of the second computing device 104 would interrupt the audio call, the virtual meeting, or the recording performed using the first computing device 102. If the microphone status 130 of the microphone 108 of the first computing device 102 is turned off and not currently recording the user of the first computing device 102, then the audio playback 124 from the speaker system 110 of the second computing device 104 would not interrupt the audio call, the virtual meeting, or recording performed using the first computing device 102. The first computing device 102 in this example is determined to have higher priority than the second computing device 104 because the first computing device 102 is engaged in an activity involving use of a microphone 108, while the second computing device 104 is engaged in consuming media.

The volume manager 118 also determines that audio playback 124 is actively output from the speaker system 110 of the second computing device 104. For example, the audio playback 124 may be video audio, call audio, music, or other audio from any type of audio media output via the speaker system 110. The audio media, for instance, may be streamed or accessed by the first computing device 102 from a web service provider 132 via the communication network 106.

The volume manager 118 then determines the volume adjustment 122 for the speaker system 110 of the second computing device 104. In some example implementations, for instance, the volume manager 118 determines the volume adjustment 122 based on microphone status 130 of the first computing device 102. For example, if the microphone status 130 is on and the user of the first computing device 102 is actively speaking, the volume manager 118 determines the volume adjustment 122 to mute or lower a volume of the speaker system 110 of the second computing device 104. In an additional example, if the microphone status 130 is on and the user of the first computing device 102 is not actively speaking, but the volume manager 118 determines the user is expected to begin speaking soon, the volume manager 118 determines the volume adjustment 122 to mute or lower a volume of the speaker system 110 of the second computing device 104. For instance, the volume manager 118 may leverage a machine learning model to determine whether the user of the first computing device 102 is expected to begin speaking by monitoring the audio call, the virtual meeting, or the recording performed using the first computing device 102. In an additional example, however, if the microphone status 130 is on and the user of the first computing device 102 is not actively speaking, but the volume manager 118 determines the user is not expected to begin speaking soon, the volume manager 118 instead determines a microphone adjustment to mute the microphone 108 of the first computing device 102. In an additional example, if the microphone status 130 is off and the user is not expected to begin speaking soon, the volume manager 118 determines that the volume adjustment 122 is not to be performed.

To perform the volume adjustment 122, the volume manager 118 sends a trigger 134 to the second computing device 104 to instruct the second computing device 104 to perform the volume adjustment 122. For example, after executing the volume adjustment 122, the volume of the speaker system 110 is muted or turned down, reducing distractions to the audio call, the virtual meeting, or the recording performed on the first computing device 102 within proximity to the second computing device 104.

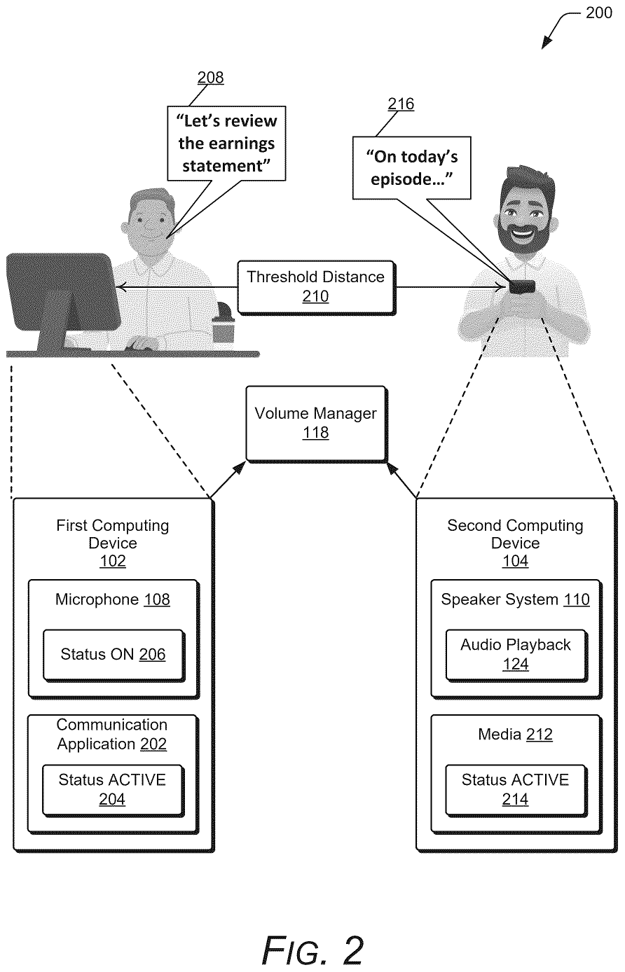

FIG. 2 illustrates an example 200 of adjusting volume of audio playback based on microphone status, including determining a status of a microphone associated with a first computing device, as described herein. In the example 200, a volume manager 118 configured for adjusting volume of audio playback based on microphone status may be implemented in a first computing device 102, a second computing device 104, or in another device or network-based cloud that is in communication with the first computing device 102 and the second computing device 104.

As illustrated in this example, a user of the first computing device 102 is conducting a call using the first computing device 102 via the communication network 106. For instance, the first computing device 102 conducts the call using a communication application 202. The volume manager 118 determines that a status 204 of the communication application 202 is active. To do this, the volume manager 118 receives usage data from the first computing device 102 indicating that the communication application 202 is currently in use, or receives any other type of data indicating that the status 204 of the communication application 202 is active, such as account data related to the user of the first computing device 102 indicating that the user is conducting a call using the first computing device 102. Although this example involves the communication application 202 used to conduct a call, the communication application 202 performs any other functionality in other example implementations, such as conducting meetings, or recording audio and/or video.

The volume manager 118 also determines that a status 206 of the microphone 108 of the first computing device 102 is active. For example, the volume manager 118 may determine the status 206 of the microphone 108 based on received data from the first computing device 102 indicating that the microphone 108 is turned on or off. For instance, data specifying that the microphone 108 is muted indicates that the microphone 108 is turned off. Additionally or alternatively, the volume manager 118 may determine the status 206 of the microphone 108 based audio data received at the microphone 108 indicating that the status 206 of the microphone 108 is on. In this example, the microphone 108 receives speech audio 208 including the user of the first computing device 102 saying “Let's review the earnings statement” during the call. Based on the speech audio 208, for instance, the volume manager 118 determines that the status 206 of the microphone 108 is on.

In some example implementations, the volume manager 118 may also determine that the first computing device 102 and the second computing device 104 are physically within proximity of each other, such as within a threshold distance 210. To do this, the volume manager 118 receives location data from the location device 114 of the first computing device 102 and the second computing device 104 and compares the location data to determine whether the first computing device 102 and the second computing device 104 are located within the threshold distance 210. For example, the location device 114 is a GPS device, and the volume manager 118 determines the location 116 based on GPS data. Additionally or alternatively, the location device 114 involves a UWB tag incorporated in the first computing device 102 and the second computing device 104, and the volume manager 118 determines the first computing device 102 is within the threshold distance by comparing the signal path loss from received signals from the UWB tags. In some implementations, the volume manager 118 accesses a database 126 via the communication network 106 that includes computing device identity information 128. As illustrated in this example, the volume manager 118 determines that the first computing device 102 and the second computing device 104 are located within the threshold distance 210.

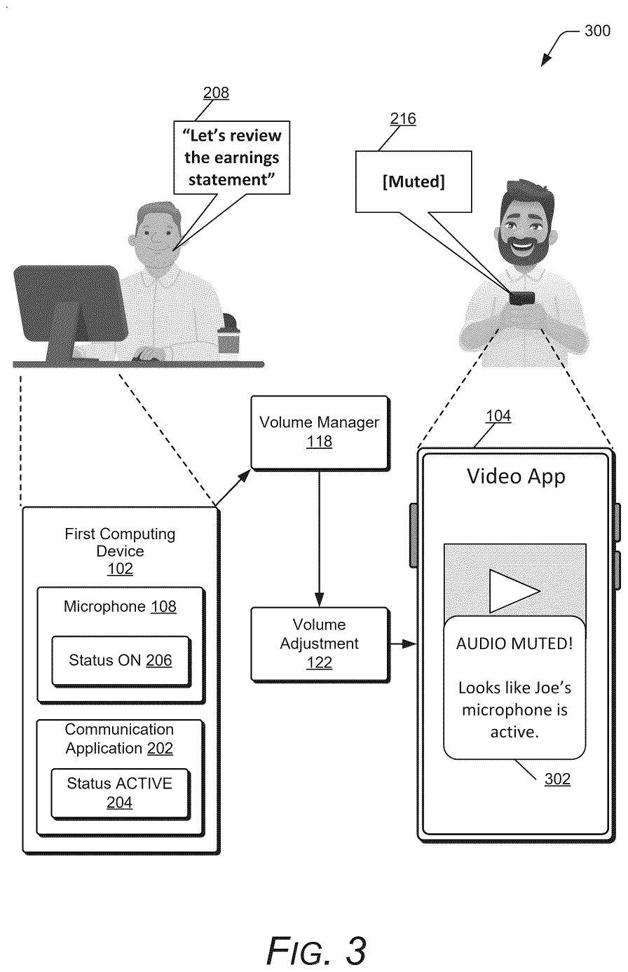

As illustrated in this example, the second computing device 104 includes a speaker system 110 which may be configured to output audio playback 124. Because the first computing device 102 and the second computing device 104 are within the threshold distance 210 of each other, the audio playback 124 may interrupt the audio call, the virtual meeting, or the recording occurring using the first computing device 102 when media 212 accessed on the second computing device 104 has a status 214 of active. The volume manager 118 may determine that the media is active on the second computing device based on received data from the second computing device 104 indicating that the speaker system 110 is actively outputting audio. Additionally or alternatively, the volume manager 118 may determine the status 214 of the media 212 based on detecting the audio playback 124 from the second computing device 104. In this example, volume manager 118 detects media audio 216 of a podcast playing on the second computing device 104, which starts off by saying “On today's episode...” Based on the media audio 216, for instance, the volume manager 118 determines that the status 214 of the media 212 is active, which is used to adjust a volume of the audio playback as described with regard to FIG. 3 below.

FIG. 3 illustrates an example 300 of adjusting volume of audio playback based on microphone status, including sending a trigger to a second computing device to adjust a volume of audio playback, as described herein. The example 300 is a continuation of the example 200 described with respect to FIG. 2. After determining that the status 204 of the communication application 202 on the first computing device 102 is active, the status 206 of the microphone 108 of the first computing device 102 is on, the first computing device 102 and the second computing device 104 are located within a threshold distance 210, and the status 214 of the media 212 on the second computing device 104 is active, the volume manager 118 initiates a volume adjustment 122 on the second computing device 104.

The volume manager 118 may transmit instructions to the second computing device 104 to instruct the second computing device 104 to perform a volume adjustment 122. In this example, the volume adjustment 122 includes muting the speaker system 110 of the second computing device 104. For example, the media audio 216 played from the second computing device 104 is muted. In other example implementations, however, the volume adjustment 122 may involve lowering a volume of the speaker system 110. In implementations involving the volume manager 118 housed internally in the second computing device 104, the volume manager 118 causes the volume adjustment 122 to the second computing device 104.

As illustrated in this example, the volume manager 118 causes display of a message 302 on a display of the second computing device 104 indicating the volume adjustment 122. For example, the message reads “Audio Muted! Looks like Joe's microphone is active.” The message 302 for example, may indicate to the user of the second computing device 104 that the audio playback 124 from the second computing device 104 is interrupting activity on the first computing device 102.

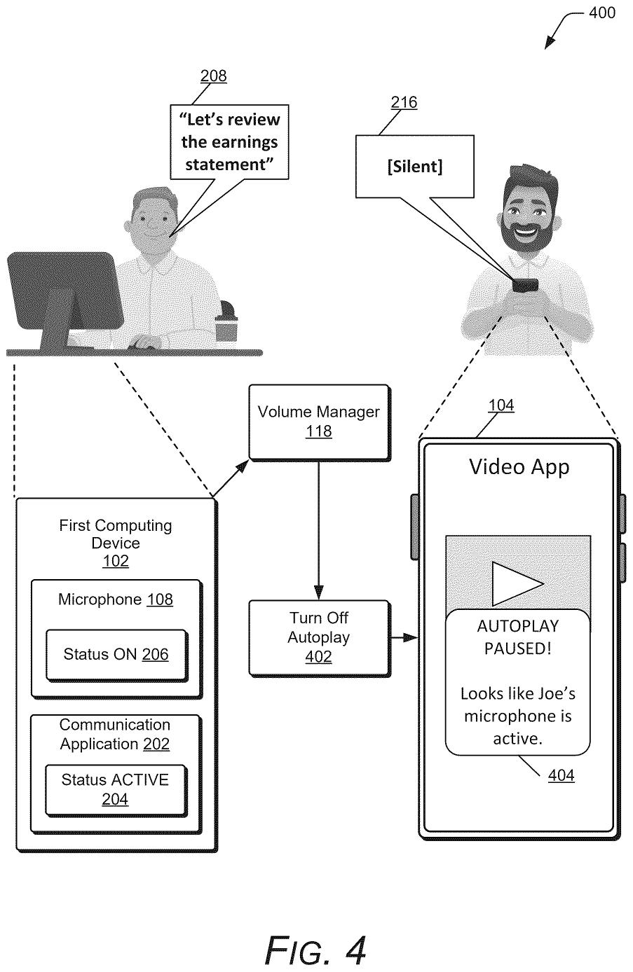

FIG. 4 illustrates an example 400 of adjusting volume of audio playback based on microphone status, including sending a trigger to a second computing device to turn off autoplay, as described herein. The example 400 is a continuation of the example 200 described with respect to FIG. 2 or the example 300 described with respect to FIG. 3. After determining that the status 204 of the communication application 202 on the first computing device 102 is active, the status 206 of the microphone 108 of the first computing device 102 is on, the first computing device 102 and the second computing device 104 are located within a threshold distance 210, and the status 214 of the media 212 on the second computing device 104 is active, the volume manager 118 turns off autoplay 402 on the second computing device 104.

The volume manager 118 may transmit instructions to the second computing device 104 to pause or end autoplay 402. The autoplay 402, for instance, may be an active feature on the second computing device 104 that involves automatically playing audio and/or video next in a queue on a media app on the second computing device 104. Additionally or alternatively, the autoplay 402 may involve automatically playing advertisements or pop-up videos on websites or social media accessed on the second computing device 104. Although the media initiated by the autoplay 402 on the second computing device 104 may be unintentional, the media is interruptive to the user of the first computing device 102 during the audio call, the virtual meeting, or the recording and is therefore turned off by the volume manager 118.

As illustrated in this example, the volume manager 118 causes display of a message 404 on a display of the second computing device 104 indicating the autoplay 402 is paused. For example, the message reads “Autoplay paused! Looks like Joe's microphone is active.” The message 302 for example, may indicate to the user of the second computing device 104 that the audio playback 124 from the second computing device 104 is interrupting activity on the first computing device 102. The instructions to turn off the autoplay 402 may be performed separately or in conjunction with the instructions to perform the volume adjustment 122 described with respect to FIG. 3.

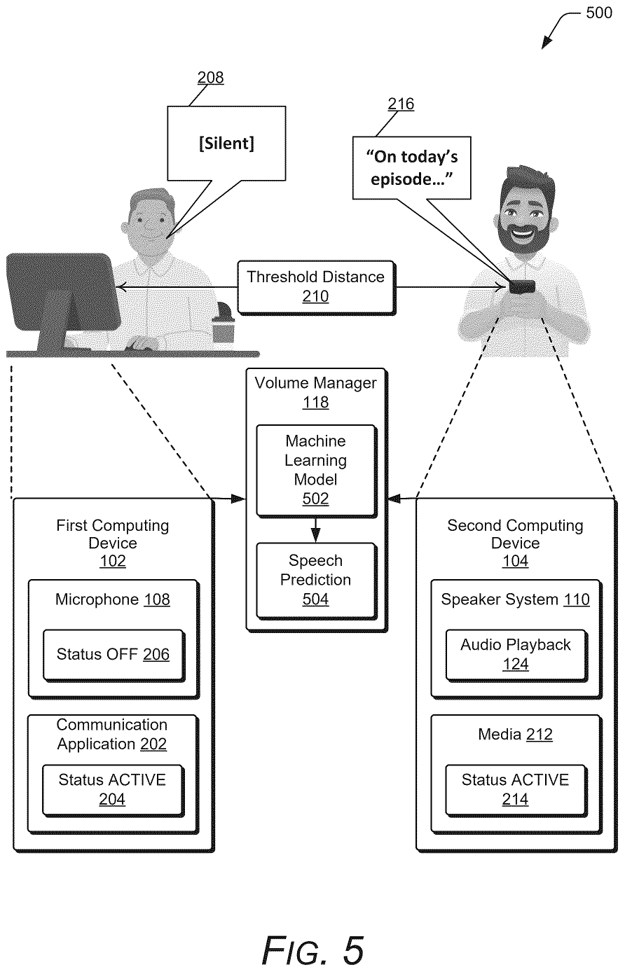

FIG. 5 illustrates an example 500 of adjusting volume of audio playback based on microphone status, including determining whether a user of the first computing device is expected to speak, as described herein. The example 500 is an alternative of the example 200 described with respect to FIG. 2.

As illustrated in this example, a user of the first computing device 102 is conducting a call using the first computing device 102 via the communication network 106. For instance, the first computing device 102 conducts the call using a communication application 202. The volume manager 118 determines that a status 204 of the communication application 202 is active, as discussed in detail with respect to FIG. 2.

The volume manager 118 also determines that a status 206 of the microphone 108 of the first computing device 102 is off. For example, the volume manager 118 may determine the status 206 of the microphone 108 based on received data from the first computing device 102 indicating that the microphone 108 is turned on or off. Additionally or alternatively, the volume manager 118 may determine the status 206 of the microphone 108 based audio data received at the microphone 108 indicating that the status 206 of the microphone 108 is on or off. In this example, the microphone 108 determines that speech audio 208 is absent during the call and that the user of the first computing device 102 is silent. Based on the absence of the speech audio 208, for instance, the volume manager 118 determines that the status 206 of the microphone 108 is off.

Although the status 206 of the microphone is off, the volume manager 118 may use a machine learning model 502 to determine a speech prediction 504. The speech prediction 504 indicates a likelihood that the user of the first computing device 102 speaks in the future. For example, the speech prediction 504 may indicate that the user of the first computing device 102 is expected to speak within a threshold amount of time based on a determined context of an activity related to the communication application 202, such as an audio call, a virtual meeting, or a recording. For example, the microphone 108 may be temporarily muted while the user of the first computing device 102 listens to a presentation during a virtual meeting, but the machine learning model 502 determines the user is expected to unmute the microphone 108 and ask questions when the presentation concludes. The machine learning model 502 in this example may be trained on data involving historic examples of microphone usage and user interaction with calls, meetings, and recordings.

In some example implementations, the volume manager 118 may also determine that the first computing device 102 and the second computing device 104 are physically within proximity of each other, as discussed in detail with respect to FIG. 2. As illustrated in this example, the volume manager 118 determines that the first computing device 102 and the second computing device 104 are located within the threshold distance 210.

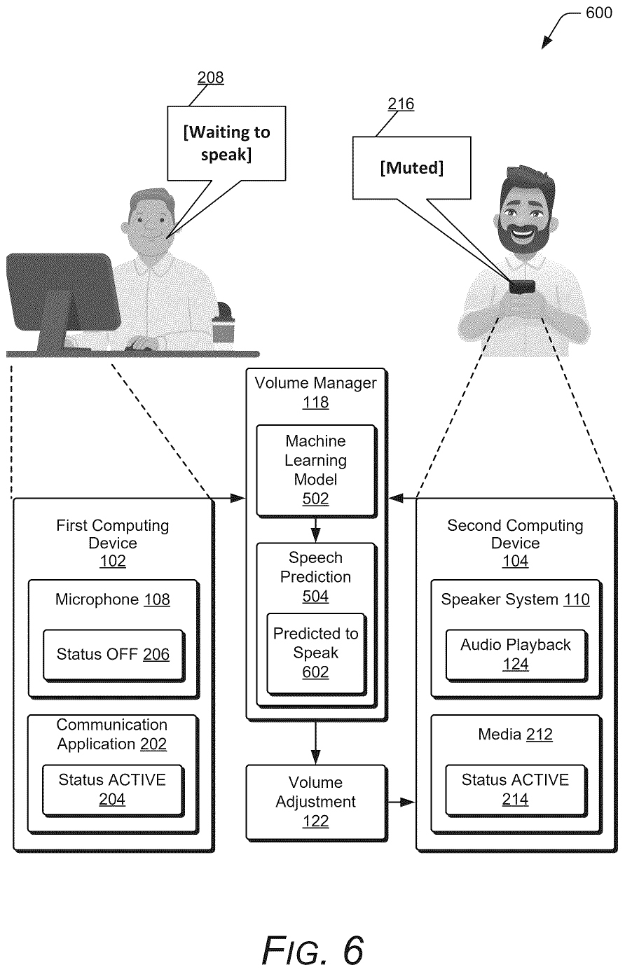

As illustrated in this example, the second computing device 104 includes a speaker system 110 which may be configured to output audio playback 124. Because the first computing device 102 and the second computing device 104 are within the threshold distance 210 of each other, the audio playback 124 may interrupt the audio call, the meeting, or the recording occurring using the first computing device 102 when media 212 accessed on the second computing device 104 has a status 214 of active and if the user of the first computing device 102 is expected to speak with the microphone 108 turned on. The volume manager 118 may determine that the media is active on the second computing device based on received data from the second computing device 104 indicating that the speaker system 110 is actively outputting audio. Additionally or alternatively, the volume manager 118 may determine the status 214 of the media 212 based on detecting the audio playback 124 from the second computing device 104. In this example, volume manager 118 detects media audio 216 of a podcast playing on the second computing device 104, which starts off by saying “On today's episode . . . ” Based on the media audio 216, for instance, the volume manager 118 determines that the status 214 of the media 212 is active, which is used to adjust a volume of the audio playback as described with regard to FIG. 6 below.

FIG. 6 illustrates an example 600 of adjusting volume of audio playback based on microphone status, including sending a trigger to a second computing device to adjust a volume of audio playback in response to determining that the user of the first computing device is expected to speak, as described herein. The example 600 is a continuation of the example 500 described with respect to FIG. 5. After determining that the status 204 of the communication application 202 on the first computing device 102 is active, the status 206 of the microphone 108 of the first computing device 102 is off, the first computing device 102 and the second computing device 104 are located within a threshold distance 210, and the status 214 of the media 212 on the second computing device 104 is active, the volume manager 118 determines the speech prediction 504.

As illustrated in this example, the volume manager 118 leverages the machine learning model 502 to determine that the user of the first computing device 102 is predicted to speak 602, even though the status 206 of the microphone 108 is off. For example, the machine learning model 502 determines that the user of the first computing device 102 is not currently speaking because another attendee of a virtual meeting is speaking, but the user of the first computing device 102 is expected to speak soon based on a schedule of events for the virtual meeting.

In response to determining that the user of the first computing device 102 is predicted to speak 602, the volume manager 118 may transmit instructions to the second computing device 104 to perform a volume adjustment 122. In this example, the volume adjustment 122 includes muting the speaker system 110 of the second computing device 104. For example, the media audio 216 played from the second computing device 104 is muted. In other example implementations, however, the volume adjustment 122 may involve lowering a volume of the speaker system 110. In implementations involving the volume manager 118 housed internally in the second computing device 104, the volume manager 118 causes the volume adjustment 122 to the second computing device 104. Additionally, in some example implementations, the volume manager 118 may cause display of a message on a display of the second computing device 104 indicating the volume adjustment 122 and indicating to the user of the second computing device 104 that the audio playback 124 from the second computing device 104 is interrupting activity on the first computing device 102.

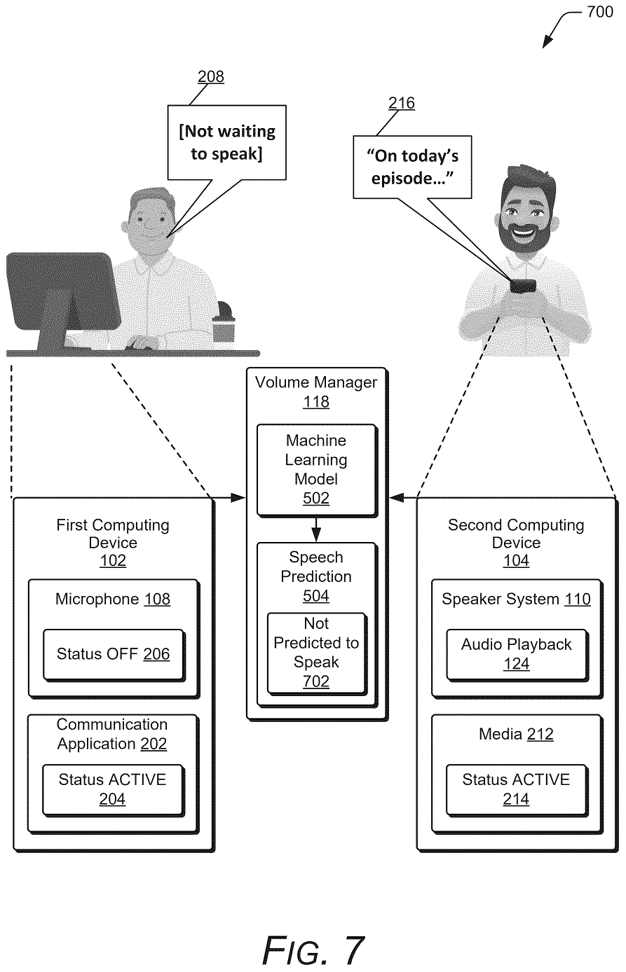

FIG. 7 illustrates an example 700 of adjusting volume of audio playback based on microphone status, determining that the user of the first computing device is not expected to speak, as described herein. The example 700 is an alternative implementation of the example 600 described with respect to FIG. 6. After determining that the status 204 of the communication application 202 on the first computing device 102 is active, the status 206 of the microphone 108 of the first computing device 102 is off, the first computing device 102 and the second computing device 104 are located within a threshold distance 210, and the status 214 of the media 212 on the second computing device 104 is active, the volume manager 118 determines the speech prediction 504.

As illustrated in this example, the volume manager 118 leverages the machine learning model 502 to determine that the user of the first computing device 102 is not predicted to speak 702. For example, the machine learning model 502 determines that the user of the first computing device 102 is not currently speaking because another attendee of a virtual meeting is speaking, and the user of the first computing device 102 is not expected to speak soon based on a schedule of events for the virtual meeting. For example, the machine learning model 502 may determine that the virtual meeting is configured to not allow questions from attendees who are not presenting. Therefore, the speech prediction 504 indicates that the user of the first computing device 102 is not predicted to speak 702.

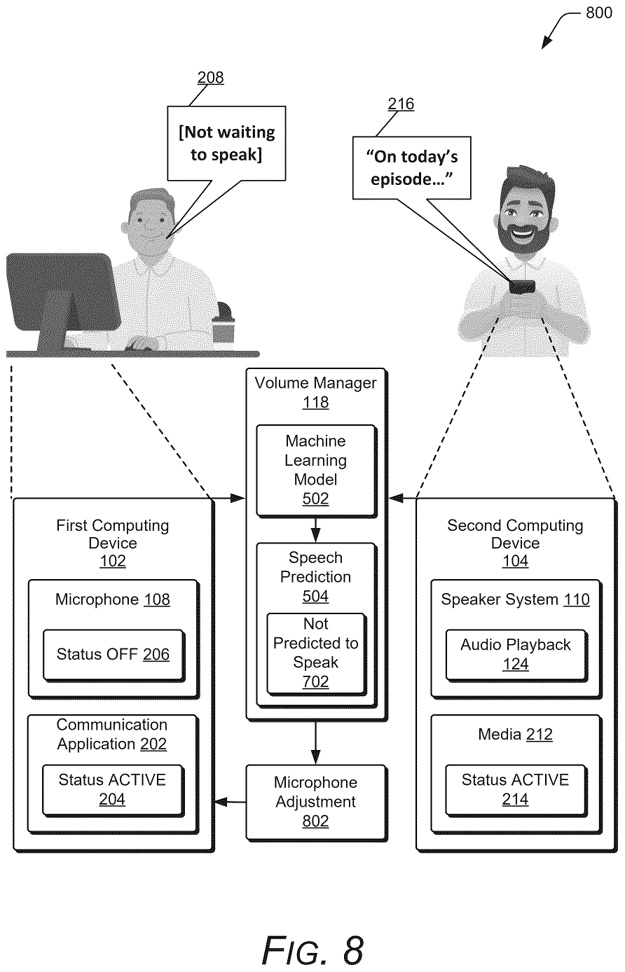

FIG. 8 illustrates an example 800 of adjusting volume of audio playback based on microphone status, including sending a trigger to the first computing device to mute a microphone in response to determining that the user of the first computing device is not expected to speak, as described herein. The example 800 is a continuation of the example 700 described with respect to FIG. 7.

In response to determining that the user of the first computing device 102 is not predicted to speak 702, the volume manager 118 may transmit instructions to the first computing device 102 to perform a microphone adjustment 802. In this example, the microphone adjustment 802 involves muting the microphone 108 of the first computing device 102. For example, while the microphone 108 is muted, the microphone 108 does not receive audio input from the user of the first computing device 102 to avoid disruptions to live activities performed using the first computing device 102, such as audio calls or virtual meetings. In implementations involving the volume manager 118 housed internally in the first computing device 102, the volume manager 118 causes the microphone adjustment 802 to the first computing device 102. Additionally, in some example implementations, the volume manager 118 may cause display of a message on a display of the first computing device 102 indicating the microphone adjustment 802.

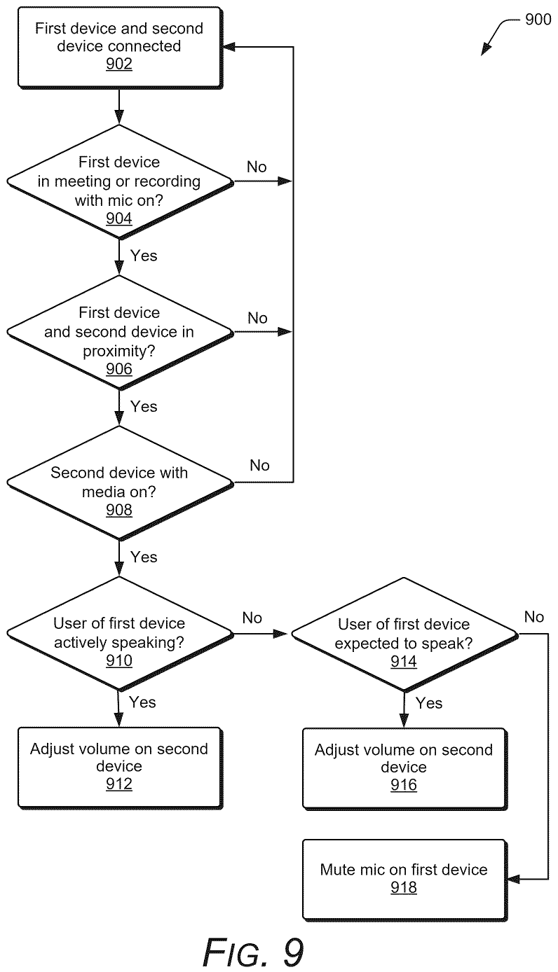

FIG. 9 is a flowchart 900 illustrating an example of adjusting volume of audio playback based on microphone status in accordance with one or more implementations, as described herein.

At 902, a first computing device 102 and a second computing device 104 are connected via a communication network 106. A volume manager 118 determines, at 904, whether the first computing device 102 is being used to conduct an audio call, a virtual meeting, or a recording with the microphone 108 of the first computing device 102 turned on. If the first computing device 102 is not being used to conduct an audio call, a virtual meeting, or a recording with the microphone 108 of the first computing device 102 turned on, the volume manager 118 continues to monitor for the first computing device 102 being used to conduct an audio call, a virtual meeting, or a recording with the microphone 108 of the first computing device 102 turned on.

At 906, the volume manager 118 monitors whether the first computing device 102 is located within a close proximity of a second computing device 104. For example, the volume manager 118 determines whether the first computing device 102 and the second computing device 104 are located within a threshold distance based on location data, calendar data, or other location-specifying data from the first computing device 102 and the second computing device 104 or associated with the users of the devices. If the second computing device 104 is not co-located with the first computing device 102, the volume manager 118 continues to monitor whether the first computing device 102 is located within a close proximity of a second computing device 104.

At 908, the volume manager 118 monitors whether the second computing device 104 has media playing. For example, the volume manager 118 detects whether the second computing device 104 is playing media that outputs audio playback 124 that interrupts the audio call, the virtual meeting, or the recording conducted on the second computing device 104. If the second computing device 104 does not have media playing, the volume manager 118 continues to monitor whether the second computing device 104 has media playing.

At 910, the volume manager 118 monitors whether the user of the first computing device 102 is actively speaking. For example, the volume manager 118 determines whether the microphone 108 of the first computing device 102 is actively receiving audio input from the user. If the user of the first computing device 102 is actively speaking, at 912 the volume manager 118 causes a volume adjustment 122 of the speaker system 110 of the second computing device 104. If the user of the first computing device 102 is not actively speaking, at 914 the volume manager 118 determines whether the user of the first computing device 102 is expected to speak. For example, the volume manager 118 leverages a machine learning model 502 to determine whether the user of the first computing device 102 is expected to speak based on a context of the audio call, the virtual meeting, or the recording conducted on the first computing device 102. If the user of the first computing device 102 is expected to speak, at 916 the volume manager 118 causes a volume adjustment 122 of the speaker system 110 of the second computing device 104. If the user of the first computing device 102 is not expected to speak, at 918 the volume manager 118 causes a microphone adjustment 802 to the microphone 108 of the first computing device 102. For example, the volume manager 118 mutes the microphone 108 of the first computing device 102 so that the microphone 108 does not receive audio input.

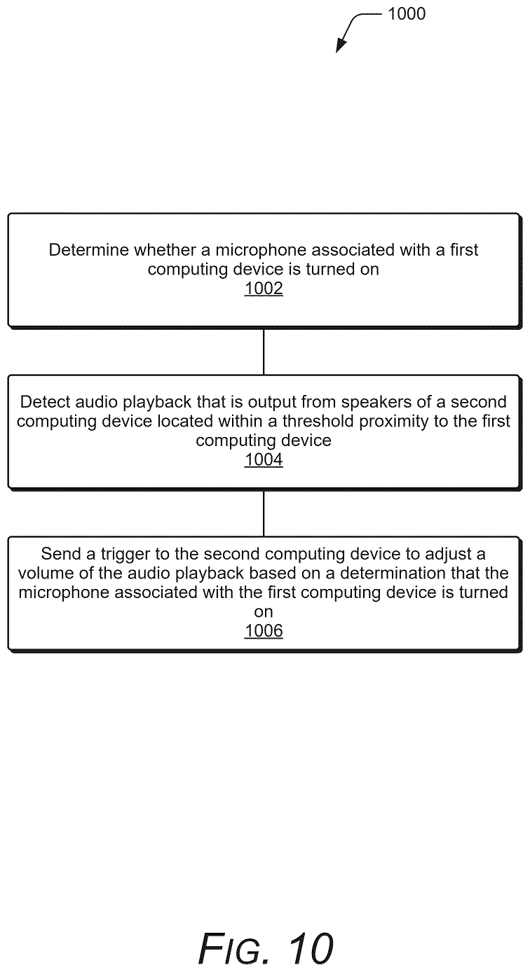

Example methods 1000, 1100, and 1200 are described with reference to respective FIGS. 10, 11, and 12 in accordance with one or more implementations of adjusting volume of audio playback based on microphone status, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 10 illustrates example method(s) 1000 for adjusting volume of audio playback based on microphone status. The order in which the method is described is not intended to be construed as a limitation, and any number or combination of the described method operations may be performed in any order to perform a method, or an alternate method.

At 1002, it is determined whether a microphone associated with a first computing device is turned on. For example, the volume manager 118 determines whether a microphone 108 associated with the first computing device 102 is turned on. In some examples, the volume manager 118 determines an identity of the first computing device 102 based on detecting that the first computing device 102 is actively recording or participating in a call. Additionally, in some examples the volume manager 118 determines, using a machine learning model 502, whether the first computing device 102 is expected to receive audio input at the microphone 108.

At 1004, audio playback is detected that is output from speakers of a second computing device located within a threshold proximity to the first computing device. For example, the volume manager 118 detects audio playback 124 is output from speakers of a second computing device 104 located within a threshold proximity to the first computing device 102.

At 1006, a trigger is sent to the second computing device to adjust a volume of the audio playback based on a determination that the microphone associated with the first computing device is turned on. For example, the volume manager 118 sends a trigger 134 to the second computing device to adjust a volume of the audio playback 124 based on a determination that the microphone 108 associated with the first computing device 102 is turned on. In some examples, the volume manager 118 instructs the second computing device 104 to lower the volume of the audio playback 124 on the second computing device 104 in response to determining that the first computing device 102 is actively receiving audio input at the microphone 108. For example, the trigger 134 may be configured to turn off auto play on the second computing device 104. In some examples, the trigger 134 is configured to cause the second computing device 104 to output an alert that the microphone 108 associated with the first computing device 102 is turned on. Additionally, in some examples the volume manager 118 instructs the second computing device 104 to lower the volume of the audio playback 124 in response to determining that the first computing device 102 is actively recording. In some examples, the volume manager 118 instructs the second computing device 104 to lower the volume of the audio playback 124 in response to determining that the first computing device 102 is expected to receive audio input at the microphone 108. Alternatively, the volume manager 118 instructs the first computing device 102 to turn off the microphone 108 associated with the first computing device 102 in response to determining that the first computing device 102 is not expected to receive audio input at the microphone 108.

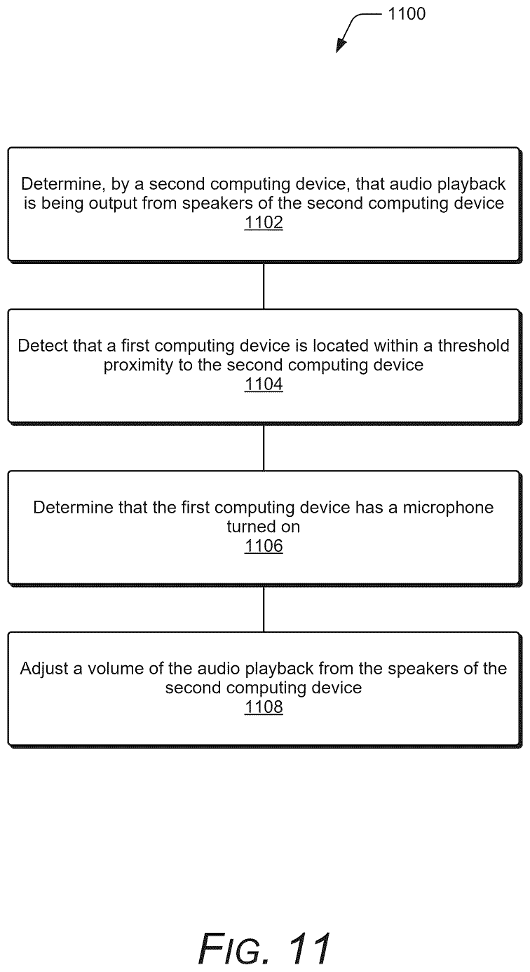

FIG. 11 illustrates example method(s) 1100 for adjusting volume of audio playback based on microphone status. The order in which the method is described is not intended to be construed as a limitation, and any number or combination of the described method operations may be performed in any order to perform a method, or an alternate method.

At 1102, it is determined, by a second computing device, that audio playback is being output from speakers of the second computing device. For example, the volume manager 118 determines that audio playback 124 is being output from speakers of the second computing device 104.

At 1104, a first computing device located within a threshold proximity to the second computing device is detected. For example, the volume manager 118 detects that a first computing device 102 is located within a threshold proximity to the second computing device 104.

At 1106, it is determined that the first computing device has a microphone turned on. For example, the volume manager 118 determines that the first computing device 102 has a microphone 108 turned on. In some examples, the volume manager 118 uses a machine learning model 502, whether a user of the first computing device 102 is expected to speak.

At 1108, a volume of the audio playback from the speakers of the second computing device is adjusted. For example, the volume manager 118 adjusts a volume of the audio playback 124 from the speakers of the second computing device 104. In some examples, the volume manager 118 instructs the second computing device 104 to lower the volume of the audio playback 124 in response to determining that the first computing device 102 is actively receiving audio input. Additionally, in some examples the volume manager 118 instructs the second computing device 104 to turn off auto play on the second computing device 104. In some examples, the volume manager 118 causes the second computing device 104 to output an alert that the microphone 108 associated with the first computing device 102 is turned on. Additionally, in some examples the volume manager 118 instructs the second computing device 104 to lower the volume of the audio playback 124 in response to determining that the first computing device 102 is actively recording. In some examples, the volume manager 118 instructs the second computing device 104 to lower the volume of the audio playback 124 in response to determining that the user first computing device 102 is expected to receive audio input.

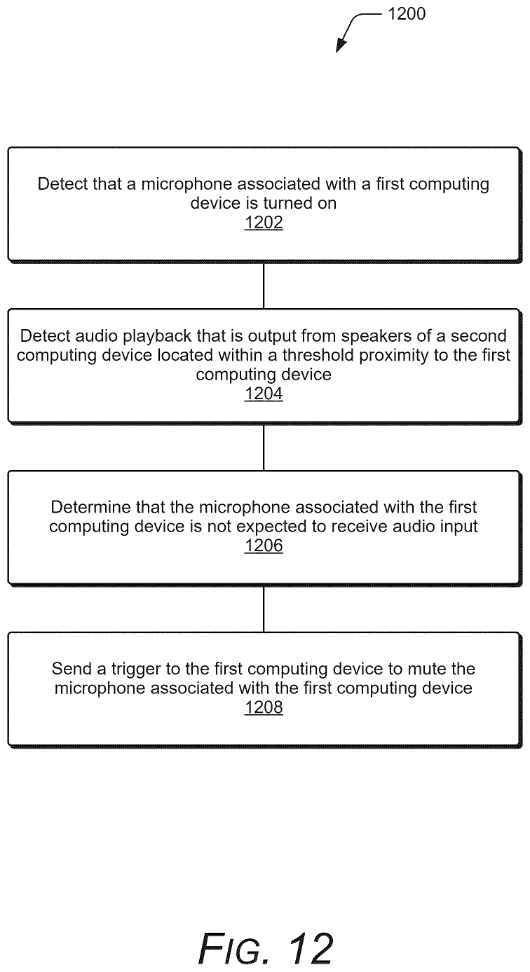

FIG. 12 illustrates example method(s) 1200 for adjusting volume of audio playback based on microphone status. The order in which the method is described is not intended to be construed as a limitation, and any number or combination of the described method operations may be performed in any order to perform a method, or an alternate method.

At 1202, a microphone associated with a first computing device is detected to be turned on. For example, the volume manager 118 detects that a microphone 108 associated with a first computing device 102 is turned on.

At 1204, audio playback that is output from speakers of a second computing device located within a threshold proximity to the first computing device is detected. For example, the volume manager 118 detects audio playback 124 that is output from speakers of a second computing device 104 located within a threshold proximity to the first computing device 102.

At 1206, it is determined that the microphone associated with the first computing device is not expected to receive audio input. For example, the volume manager 118 determines that the microphone 108 associated with the first computing device 102 is not expected to receive audio input. In some example implementations, the volume manager 118 leverages a machine learning model 502 to determine that the microphone 108 associated with the first computing device 102 is not expected to receive audio input based on a determined context of a meeting or call.

At 1208, a trigger is sent to the first computing device to mute the microphone associated with the first computing device. For example, the volume manager 118 sends a trigger to the first computing device 102 to mute the microphone 108 associated with the first computing device 102. In some example implementations, the volume manager 118 causes display of a message on a display of the first computing device 102 informing a user of the first computing device 102 that the microphone 108 is muted.

FIG. 13 illustrates various components of an example device 1300, which can implement aspects of the techniques and features for adjusting volume of audio playback based on microphone status, as described herein. The example device 1300 may be implemented as any of the devices described with reference to the previous FIG. 1-9, such as any type of a wireless device, mobile device, mobile phone, flip phone, client device, companion device, display device, tablet, computing, communication, entertainment, gaming, media playback, and/or any other type of computing, consumer, and/or electronic device. For example, the microphone 108 described with reference to FIGS. 1-12 may be implemented as the example device 1300.

The example device 1300 can include various, different communication devices 1302 that enable wired and/or wireless communication of device data 1304 with other devices. The device data 1304 can include any of the various devices data and content that is generated, processed, determined, received, stored, and/or communicated from one computing device to another. Generally, the device data 1304 can include any form of audio, video, image, graphics, and/or electronic data that is generated by applications executing on a device. The communication devices 1302 can also include transceivers for cellular phone communication and/or for any type of network data communication.

The example device 1300 can also include various, different types of data input / output (I/O) interfaces 1306, such as data network interfaces that provide connection and/or communication links between the devices, data networks, and other devices. The data I/O interfaces 1306 may be used to couple the device to any type of components, peripherals, and/or accessory devices, such as a computer input device that may be integrated with the example device 1300. The I/O interfaces 1306 may also include data input ports via which any type of data, information, media content, communications, messages, and/or inputs may be received, such as user inputs to the device, as well as any type of audio, video, image, graphics, and/or electronic data received from any content and/or data source.

The example device 1300 includes a processor system 1308 of one or more processors (e.g., any of microprocessors, controllers, and the like) and/or a processor and memory system implemented as a system-on-chip (SoC) that processes computer-executable instructions. The processor system 1308 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1310. The example device 1300 may also include any type of a system bus or other data and command transfer system that couples the various components within the device. A system bus can include any one or combination of different bus structures and architectures, as well as control and data lines.

The example device 1300 also includes memory and/or memory devices 1312 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1312 include volatile memory and non-volatile memory, fixed and removable media devices, and any suitable memory device or electronic data storage that maintains data for computing device access. The memory devices 1312 can include various implementations of random-access memory (RAM), read-only memory (ROM), flash memory, and other types of storage media in various memory device configurations. The example device 1300 may also include a mass storage media device.

The memory devices 1312 (e.g., as computer-readable storage memory) provide data storage mechanisms, such as to store the device data 1304, other types of information and/or electronic data, and various device applications 1314 (e.g., software applications and/or modules). For example, an operating system 1316 may be maintained as software instructions with a memory device 1312 and executed by the processor system 1308 as a software application. The device applications 1314 may also include a device manager, such as any form of a control application, software application, signal-processing and control module, code that is specific to a particular device, a hardware abstraction layer for a particular device, and so on.

In this example, the device 1300 includes a volume manager 1318 that implements various aspects of the described features and techniques described herein. The volume manager 1318 may be implemented with hardware components and/or in software as one of the device applications 1314, such as when the example device 1300 is implemented as the microphone 108 described with reference to FIGS. 1-12. An example of the volume manager 1318 is the Communication network 106 implemented by the microphone 108, such as a software application and/or as hardware components in the mobile device. In implementations, the volume manager 1318 may include independent processing, memory, and logic components as a computing and/or electronic device integrated with the example device 1300.

The example device 1300 can also include a microphone 1320 (e.g., to capture an audio recording) and/or camera devices 1322, as well as device sensors 1324, such as may be implemented as components of an inertial measurement unit (IMU). The device sensors 1324 may be implemented with various sensors, such as a gyroscope, an accelerometer, and/or other types of motion sensors to sense motion of the device. The device sensors 1324 can generate sensor data vectors having three-dimensional parameters (e.g., rotational vectors in x, y, and z-axis coordinates) indicating location, position, acceleration, rotational speed, and/or orientation of the device. The example device 1300 can also include one or more power sources 1326, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1300 can also include an audio and/or video processing system 1328 that generates audio data for an audio system 1330 and/or generates display data for a display system 1332. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1300. Alternatively, the audio system and/or the display system are external, peripheral components to the example device.

Although implementations for adjusting volume of audio playback based on microphone status have been described in language specific to features and/or methods, the appended claims are not necessarily limited to the specific features or methods described. Rather, the specific features and methods are disclosed as example implementations for adjusting volume of audio playback based on microphone status, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:
In some aspects, the techniques described herein relate to a first computing device, including: at least one memory, and at least one processor coupled with the at least one memory and configured to cause the first computing device to: determine whether a microphone associated with the first computing device is turned on, detect audio playback that is output from speakers of a second computing device located within a threshold proximity to the first computing device, and output a trigger to cause one or more of the second computing device to adjust a volume of the audio playback or the first computing device to mute the microphone based on a determination that the microphone associated with the first computing device is turned on.

In some aspects, the techniques described herein relate to a first computing device, wherein the at least one processor is further configured to cause the first computing device to instruct the second computing device to lower the volume of the audio playback on the second computing device in response to determining that the first computing device is actively receiving audio input at the microphone.

In some aspects, the techniques described herein relate to a first computing device, wherein the at least one processor is further configured to cause the first computing device to determine an identity of the second computing device in response to detecting that the first computing device is actively recording or participating in an audio call or a virtual meeting.

In some aspects, the techniques described herein relate to a first computing device, wherein the trigger is configured to instruct the second computing device to turn off auto play on the second computing device.

In some aspects, the techniques described herein relate to a first computing device, wherein the trigger is configured to cause the second computing device to output an alert that the microphone associated with the first computing device is turned on.

In some aspects, the techniques described herein relate to a first computing device, wherein the at least one processor is further configured to cause the first computing device to instruct the second computing device to lower the volume of the audio playback on the second computing device in response to determining that the first computing device is actively recording audio.

In some aspects, the techniques described herein relate to a first computing device, wherein the at least one processor is further configured to cause the first computing device to determine, using a machine learning model, whether the first computing device is expected to receive audio input at the microphone.

In some aspects, the techniques described herein relate to a first computing device, wherein the at least one processor is further configured to cause the first computing device to instruct the second computing device to lower the volume of the audio playback on the second computing device in response to determining that the first computing device is expected to receive audio input at the microphone.

In some aspects, the techniques described herein relate to a first computing device, wherein the at least one processor is further configured to cause the first computing device to mute the microphone associated with the first computing device in response to determining that the first computing device is not expected to receive audio input at the microphone.

In some aspects, the techniques described herein relate to a second computing device, including: at least one memory, and at least one processor coupled with the at least one memory and configured to cause the second computing device to: determine whether a microphone associated with a first computing device is turned on, detect audio playback that is output from speakers of the second computing device located within a threshold proximity to the first computing device, and output a trigger to cause one or more of the second computing device to adjust a volume of the audio playback or the first computing device to mute the microphone based on a determination that the microphone associated with the first computing device is turned on.

In some aspects, the techniques described herein relate to a second computing device, wherein the at least one processor is further configured to cause the second computing device to lower the volume of the audio playback on the second computing device in response to determining that the first computing device is actively receiving audio input at the microphone.

In some aspects, the techniques described herein relate to a second computing device, wherein the at least one processor is further configured to cause the second computing device to determine an identity of the first computing device in response to detecting that the first computing device is actively recording or participating in an audio call or a virtual meeting.

In some aspects, the techniques described herein relate to a second computing device, wherein the trigger is configured to cause the second computing device to output an alert that the microphone associated with the first computing device is turned on.

In some aspects, the techniques described herein relate to a second computing device, wherein the at least one processor is further configured to cause the second computing device to lower the volume of the audio playback on the second computing device in response to determining that the first computing device is actively recording audio.

In some aspects, the techniques described herein relate to a second computing device, wherein the at least one processor is further configured to cause the second computing device to lower the volume of the audio playback on the second computing device in response to determining, using a machine learning model, that the first computing device is expected to receive audio input at the microphone.

In some aspects, the techniques described herein relate to a second computing device, wherein the at least one processor is further configured to cause the second computing device to mute the microphone associated with the first computing device in response to determining, using a machine learning model, that the first computing device is not expected to receive audio input at the microphone.

In some aspects, the techniques described herein relate to a method including: determining that a first computing device has a microphone turned on, determining that a second computing device is engaged in outputting audio playback from speakers of the second computing device, detecting that the first computing device is located within a threshold proximity to the second computing device, and outputting a trigger to cause one or more of the second computing device to adjust a volume of the audio playback or the first computing device to mute the microphone.

In some aspects, the techniques described herein relate to a method, further including lowering the volume of the audio playback in response to determining that the first computing device is actively receiving audio input at the microphone or is actively recording audio.

In some aspects, the techniques described herein relate to a method, further including turning off auto play on the second computing device.

In some aspects, the techniques described herein relate to a method, further including lowering the volume of the audio playback in response to determining, using a machine learning model, that the first computing device is expected to receive audio input at the microphone.

1. A first computing device, comprising:
at least one memory; and
at least one processor coupled with the at least one memory and configured to cause the first computing device to:
determine whether a microphone associated with the first computing device is turned on;
detect audio playback that is output from speakers of a second computing device located within a threshold proximity to the first computing device; and
output a trigger to cause one or more of the second computing device to adjust a volume of the audio playback or the first computing device to mute the microphone based on a determination that the microphone associated with the first computing device is turned on.

2. The first computing device of claim 1, wherein the at least one processor is further configured to cause the first computing device to instruct the second computing device to lower the volume of the audio playback on the second computing device in response to determining that the first computing device is actively receiving audio input at the microphone.

3. The first computing device of claim 1, wherein the at least one processor is further configured to cause the first computing device to determine an identity of the second computing device in response to detecting that the first computing device is actively recording or participating in an audio call or a virtual meeting.

4. The first computing device of claim 1, wherein the trigger is configured to instruct the second computing device to turn off auto play on the second computing device.

5. The first computing device of claim 1, wherein the trigger is configured to cause the second computing device to output an alert that the microphone associated with the first computing device is turned on.

6. The first computing device of claim 1, wherein the at least one processor is further configured to cause the first computing device to instruct the second computing device to lower the volume of the audio playback on the second computing device in response to determining that the first computing device is actively recording audio.

7. The first computing device of claim 1, wherein the at least one processor is further configured to cause the first computing device to determine, using a machine learning model, whether the first computing device is expected to receive audio input at the microphone.

8. The first computing device of claim 7, wherein the at least one processor is further configured to cause the first computing device to instruct the second computing device to lower the volume of the audio playback on the second computing device in response to determining that the first computing device is expected to receive the audio input at the microphone.

9. The first computing device of claim 7, wherein the at least one processor is further configured to cause the first computing device to mute the microphone associated with the first computing device in response to determining that the first computing device is not expected to receive the audio input at the microphone.

10. A second computing device, comprising:
at least one memory; and
at least one processor coupled with the at least one memory and configured to cause the second computing device to:
determine whether a microphone associated with a first computing device is turned on;
detect audio playback that is output from speakers of the second computing device located within a threshold proximity to the first computing device; and
output a trigger to cause one or more of the second computing device to adjust a volume of the audio playback or the first computing device to mute the microphone based on a determination that the microphone associated with the first computing device is turned on.

11. The second computing device of claim 10, wherein the at least one processor is further configured to cause the second computing device to lower the volume of the audio playback on the second computing device in response to determining that the first computing device is actively receiving audio input at the microphone.

12. The second computing device of claim 10, wherein the at least one processor is further configured to cause the second computing device to determine an identity of the first computing device in response to detecting that the first computing device is actively recording or participating in an audio call or a virtual meeting.

13. The second computing device of claim 10, wherein the trigger is configured to cause the second computing device to output an alert that the microphone associated with the first computing device is turned on.

14. The second computing device of claim 10, wherein the at least one processor is further configured to cause the second computing device to lower the volume of the audio playback on the second computing device in response to determining that the first computing device is actively recording audio.

15. The second computing device of claim 10, wherein the at least one processor is further configured to cause the second computing device to lower the volume of the audio playback on the second computing device in response to determining, using a machine learning model, that the first computing device is expected to receive audio input at the microphone.

16. The second computing device of claim 10, wherein the at least one processor is further configured to cause the second computing device to mute the microphone associated with the first computing device in response to determining, using a machine learning model, that the first computing device is not expected to receive audio input at the microphone.

17. A method comprising:
detecting that a first computing device is located within a threshold proximity to a second computing device;
determining that the second computing device is engaged in outputting audio playback from speakers of the second computing device;
determining that the first computing device has a microphone turned on; and
outputting a trigger to cause one or more of the second computing device to adjust a volume of the audio playback or the first computing device to mute the microphone.

18. The method of claim 17, further comprising lowering the volume of the audio playback in response to determining that the first computing device is actively receiving audio input at the microphone or is actively recording audio.

19. The method of claim 17, further comprising turning off auto play on the second computing device.

20. The method of claim 17, further comprising lowering the volume of the audio playback in response to determining, using a machine learning model, that the first computing device is expected to receive audio input at the microphone.
